(19) United States
(12) Patent Application Publication
(10) Pub. No.: US 2026/0200235 A1
(43) Pub. Date: Jul. 16, 2026

(54) CONSUMABLE CARTRIDGE REUSE SYSTEM, CONSUMABLE CARTRIDGE REUSE METHOD, AND PRINTING APPARATUS

(71) Applicant: SEIKO EPSON CORPORATION, Tokyo (JP)

(72) Inventor: Taiki OTANI, Shiojiri-shi (JP)

(73) Assignee: SEIKO EPSON CORPORATION, Tokyo (JP)

(21) Appl. No.: 19/444,420

(22) Filed: Jan. 9, 2026

(30) Foreign Application Priority Data
Jan. 10, 2025 (JP) 2025-003941

(51) Int. Cl. B41J 2/175

(52) U.S. Cl. CPC B41J 2/17546; B41J 2/17526

(57) ABSTRACT

A consumable cartridge reuse system includes a printing apparatus including a first type terminal, a consumable cartridge configured to be attached to and detached from the printing apparatus, the consumable cartridge including a storage section that stores information and a second type terminal that is coupled to the first type terminal when the consumable cartridge is mounted on the printing apparatus, and a determination device configured to determine whether or not a used consumable cartridge is reusable. The printing apparatus records, as attachment information, the number of times the consumable cartridge is mounted on the printing apparatus in the storage section of the mounted consumable cartridge. The determination device determines whether or not the consumable cartridge is reusable, based on a comparison between a parameter obtained by using the attachment information read out from the storage section of the consumable cartridge removed from the printing apparatus and a threshold value.

The present application is based on, and claims priority from JP Application Serial Number 2025-003941, filed January 10, 2025, the disclosure of which is hereby incorporated by reference herein in its entirety.

### BACKGROUND

### Technical Field

The present disclosure relates to a consumable cartridge reuse system, a consumable cartridge reuse method, and a printing apparatus.

### Related Art

In the related art, reuse of consumable cartridges used in printing apparatuses is performed. In a technique of JP-A-2003-167486, a toner cartridge is provided with a memory and a memory interface for recording regeneration information of a component of the toner cartridge. The memory stores the regeneration information indicating the number of times the component of the toner cartridge is regenerated. In regeneration processing of the toner cartridge, the number of times the component is regenerated is read out from the memory of the toner cartridge. A predetermined number of times the component can be regenerated is compared with the read-out number of times the component is regenerated. When the number of times the component is regenerated does not exceed the number of times the component can be regenerated, the component is reused as a regenerated component together with the memory and the memory interface, and a new cartridge is assembled. The value of the number of times the component is regenerated in the memory is increased by 1.

On the other hand, when the number of times the component is regenerated exceeds the number of times the component can be regenerated, the component is not used and a new component is used to assemble a new cartridge. The value of the number of times the component is regenerated in the memory is cleared. In order to manage the number of times the component is regenerated, the memory and the memory interface are continuously reused in the assembly of the new cartridge.

A cartridge configured to be attachable to and detachable from a printing apparatus and including a memory includes terminals that constitute a portion of a circuit including the memory and that are electrically coupled to terminals of the circuit on the printing apparatus side. The terminals repeatedly come into contact with and separate from the terminals of the circuit on the printing apparatus side every time the cartridge is attached and detached. In the technique of JP-A-2003-167486, it is assumed that the memory and the memory interface are not replaced, and the deterioration of the terminal due to the contact and separation of the terminal is not considered.

### SUMMARY

The present disclosure is to solve at least a part of the above-described problems and can be realized in the following aspects.

According to an aspect of the present disclosure, there is provided a consumable cartridge reuse system. The consumable cartridge reuse system includes a printing apparatus including a first type terminal, a consumable cartridge configured to be attached to and detached from the printing apparatus, the consumable cartridge including a storage section that stores information and a second type terminal that is electrically coupled to the storage section and is coupled to the first type terminal when the consumable cartridge is mounted on the printing apparatus, and a determination device configured to determine whether or not a used consumable cartridge is reusable. The printing apparatus is configured to record, as attachment information, the number of times the consumable cartridge is mounted on the printing apparatus in the storage section of the consumable cartridge mounted on the printing apparatus. The determination device determines whether or not the consumable cartridge is reusable, based on a comparison between a parameter obtained by using the attachment information read out from the storage section of the consumable cartridge removed from the printing apparatus and a threshold value.

### BRIEF DESCRIPTION OF THE DRAWINGS

FIG. 1 is a perspective view illustrating a hardware configuration of a printing system.

FIG. 2 is an explanatory diagram illustrating a schematic configuration of the printing system.

FIG. 3 is a perspective view illustrating a configuration of a liquid accommodation container.

FIG. 4 is an explanatory diagram illustrating a configuration of a substrate.

FIG. 5 is a diagram illustrating a state in which the liquid accommodation container is mounted on a carriage.

FIG. 6 is an enlarged explanatory diagram illustrating the vicinity of a coupling mechanism.

FIG. 7 is a diagram illustrating a functional portion of a printing apparatus together with one liquid accommodation container.

FIG. 8 is a flowchart illustrating processing in the printing apparatus.

FIG. 9 is a diagram illustrating a functional portion of a determination device together with one liquid accommodation container.

FIG. 10 is a flowchart illustrating processing in the determination device.

FIG. 11 is a flowchart illustrating an additional portion of the processing in the determination device.

### DESCRIPTION OF EMBODIMENTS

### First Embodiment

### Hardware Configuration of Printing System

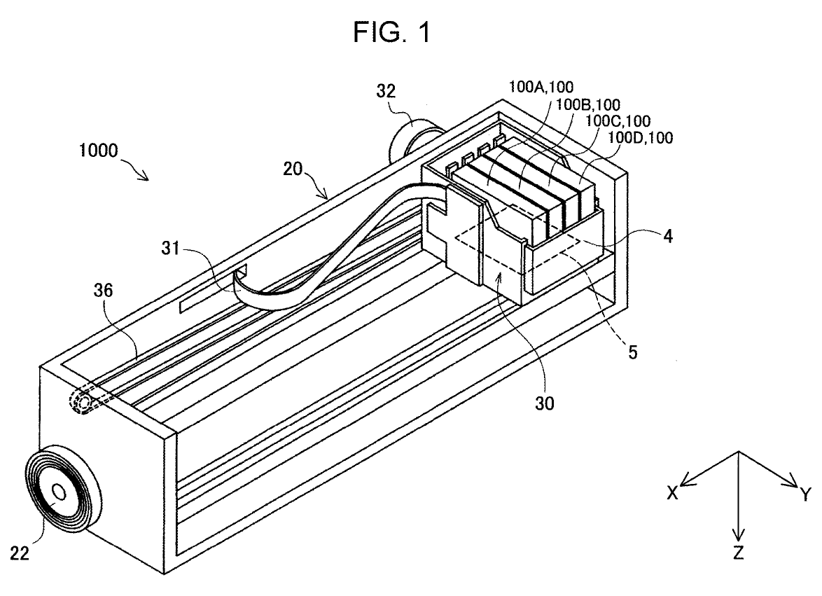

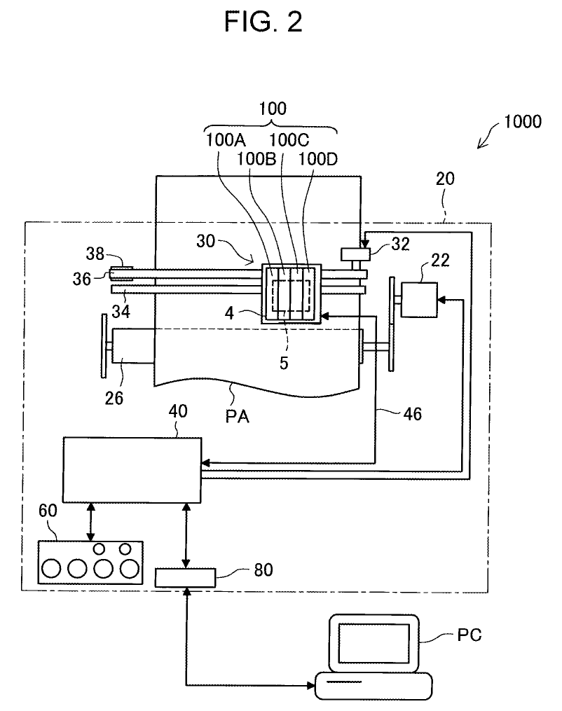

The description will be made with reference to FIGS. 1 and 2. FIG. 1 is a perspective view illustrating a hardware configuration of a printing system 1000. FIG. 2 is an explanatory diagram illustrating a schematic configuration of the printing system 1000. The printing system 1000 including a liquid accommodation container 100, together with a determination device 10, constitutes a reuse system 1 of the liquid accommodation container 100. In order to facilitate understanding of the technique, the determination device 10 is not illustrated in FIGS. 1 and 2. The determination device 10 will be described later.

FIG. 1 illustrates an X axis, a Y axis, and a Z axis that are orthogonal to each other. Directions in which arrows of the X axis, the Y axis, and the Z axis are directed indicate positive directions along the X axis, the Y axis, and the Z axis, respectively. The positive directions along the X axis, the Y axis, and the Z axis are a +X direction, a +Y direction, and a +Z direction, respectively. The negative directions along the X axis, the Y axis, and the Z axis are a -X direction, a -Y direction, and a -Z direction, respectively. When positiveness and negativeness in directions along the X axis, the Y axis, and the Z axis do not matter, the directions may be referred to as an X direction, a Y direction, and a Z direction, respectively. The X axis, the Y axis, and the Z axis illustrated in the other drawings correspond to the X axis, the Y axis, and the Z axis in FIG. 1. In FIG. 1, in a normal usage posture of the printing system 1000, a front direction of the printing system 1000 is set as the +Y direction. The +Z direction is set as a gravity direction.

The printing system 1000 includes a printing apparatus 20 and a plurality of liquid accommodation containers 100. Specifically, the printing apparatus 20 is an ink jet printer. Specifically, the liquid accommodation container 100 is an ink cartridge. The printing apparatus 20 includes a head driving mechanism, a main scanning feeding mechanism, and a sub-scanning feeding mechanism. Printing is performed using the plurality of liquid accommodation containers 100 mounted on the printing apparatus 20 by the head driving mechanism, the main scanning feeding mechanism, and the sub-scanning feeding mechanism.

The head driving mechanism includes a carriage 30. The carriage 30 includes an accommodation section 4 and a printing head 5. The liquid accommodation container 100 is configured to be attachable to and detachable from the printing apparatus 20. The accommodation section 4 is configured to attachably and detachably mount four liquid accommodation containers 100. In the present disclosure, "the liquid accommodation container 100 is mounted on the printing apparatus 20" means that the liquid accommodation container 100 is physically attached to the printing apparatus 20, and a terminal group 290 of the liquid accommodation container 100 is electrically coupled to an apparatus-side terminal group 490 of the printing apparatus 20. The terminal group 290 and the apparatus-side terminal group 490 will be described later. Each of the four liquid accommodation containers 100 is accommodated at a predetermined position of the accommodation section 4. In the present disclosure, the four liquid accommodation containers 100 accommodate liquids of different colors. The liquid is specifically ink, and is referred to as ink below. When the four liquid accommodation containers 100 are distinguished, the four liquid accommodation containers 100 are referred to as liquid accommodation containers 100A to 100D.

The printing head 5 is provided on a surface of the carriage 30 in the +Z direction. A plurality of nozzles for discharging ink droplets are provided on a surface of the printing head 5, which faces the +Z direction. Each nozzle is coupled to any of the liquid accommodation containers 100A to 100D which are mounted on the accommodation section 4 via a flow path in the carriage 30.

The accommodation section 4 is provided with a liquid introduction section 6 and a coupling mechanism 400. The liquid introduction section 6 is configured to be attachable to and detachable from a liquid supply port 104op of the liquid accommodation container 100. At the liquid introduction section 6, ink is supplied from the liquid accommodation container 100, and the ink is introduced into the printing head 5 via the flow path in the carriage 30. The coupling mechanism 400 has a plurality of apparatus-side terminal groups 490. The liquid introduction section 6 and the apparatus-side terminal group 490 will be described later.

The main scanning feeding mechanism includes a drive belt 36, a carriage motor 32, a sliding shaft 34, and a pulley 38. The drive belt 36 is an endless belt and is stretched between the carriage motor 32 and the pulley 38. The carriage 30 is fixed to the drive belt 36. The sliding shaft 34 is provided in parallel with a shaft of a paper feeding roller 26 of the sub-scanning feeding mechanism, and holds the carriage 30 to be slidable. The carriage 30 fixed to the drive belt 36 moves in the +X direction and the -X direction along the sliding shaft 34, as the carriage motor 32 rotates.

The sub-scanning feeding mechanism includes a paper feeding motor 22 and the paper feeding roller 26. The paper feeding roller 26 transports a print medium PA in the Y-direction, as the paper feeding motor 22 rotates.

The printing apparatus 20 further includes a main control section 40. The main control section 40 is coupled to the carriage 30 via a cable 31. A bus 46 is formed in the cable 31, and the main control section 40 is electrically coupled to a sub-control substrate 500 provided in the carriage 30 via the bus 46.

The main control section 40 controls each of the above-described mechanisms to realize printing processing. For example, the main control section 40 receives a print job of a user from a computer PC via a connector 80, and performs printing based on contents of the received print job. The print medium PA is transported in the +Y direction by the paper feeding roller 26, and the printing head 5 provided in the carriage 30 is moved in the +X direction and the -X direction by the drive belt 36. Therefore, ink discharged in the +Z direction from the printing head 5 can land at any position on the print medium PA. A large number of ink dots are formed at the print medium PA by a large number of ink droplets landed on the print medium PA. The large number of ink dots form an image. In the present disclosure, an "image" includes characters and symbols. In the present disclosure, the +X direction and the -X direction in which the carriage 30 moves are collectively referred to as a "main scanning direction". The -Y direction and +Y direction in which the print medium PA is fed are collectively referred to as a "sub-scanning direction".

The printing apparatus 20 further includes an operation section 60. The user makes various settings of the printing apparatus 20 or checks a status of the printing apparatus 20, by using the operation section 60.

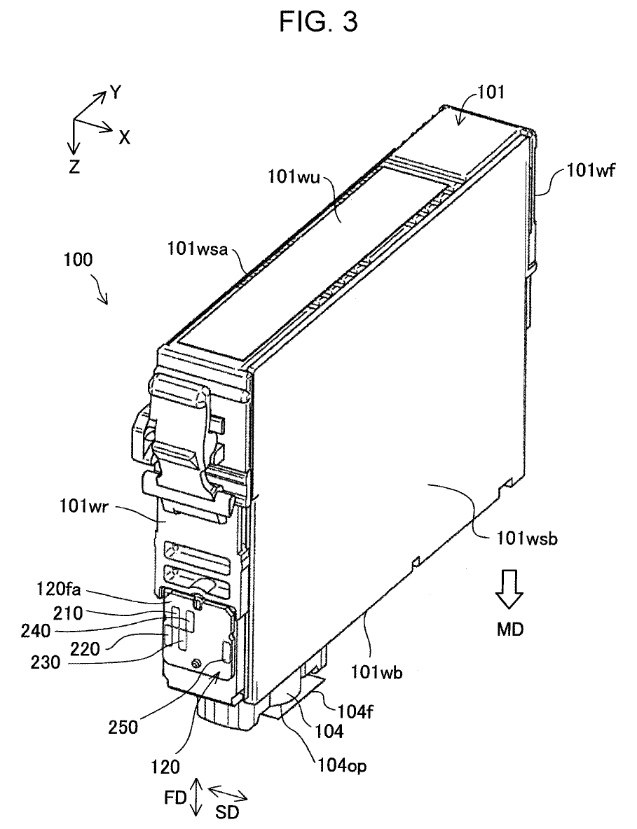

FIG. 3 is a perspective view illustrating a configuration of the liquid accommodation container 100. The directions of the X axis, Y axis, and Z axis for the liquid accommodation container 100 are set based on a state in which the printing apparatus 20 is disposed on a horizontal plane parallel to the X direction and the Y direction, and the liquid accommodation container 100 is mounted in the printing apparatus 20, as illustrated in FIG. 1.

An outer shape of the liquid accommodation container 100 is a substantially rectangular parallelepiped shape. The liquid accommodation container 100 includes a liquid accommodation body 101 configured to accommodate ink as a liquid, a liquid supply section 104 having the liquid supply port 104op, and a substrate 120.

The liquid accommodation body 101 forms an outer shell of the liquid accommodation container 100. The liquid accommodation body 101 has a first wall 101wf, a second wall 101wr, a third wall 101wb, a fourth wall 101wu, a fifth wall 101wsa, and a sixth wall 101wsb. An ink chamber that accommodates ink is partitioned inside the liquid accommodation body 101 by the six walls 101wf, 101wr, 101wb, 101wu, 101wsa, and 101wsb. The first wall 101wf is a wall on a +Y direction side and forms a front wall. The front wall is directed to a front side of the printing system 1000. The second wall 101wr faces the first wall 101wf. The second wall 101wr is a wall on a -Y direction side and forms a rear wall. The rear wall is directed to a rear side of the printing system 1000. The third wall 101wb is a wall on a +Z direction side and forms a bottom wall. The fourth wall 101wu faces the third wall 101wb. The fourth wall 101wu is a wall on a -Z direction side and forms an upper wall. The fifth wall 101wsa is a wall on a -X direction side and forms a right side wall. The sixth wall 101wsb faces the fifth wall 101wsa. The sixth wall 101wsb is a wall on a +X direction side and forms a left side wall.

The liquid supply section 104 is a tubular member that protrudes from the third wall 101wb. The liquid supply port 104op is located on a tip side of the liquid supply section 104. The liquid supply port 104op communicates with the ink chamber of the liquid accommodation body 101. When the liquid accommodation container 100 is mounted on the carriage 30 of the printing apparatus 20, the ink is supplied through the liquid supply port 104op to the liquid introduction section 6 of the carriage 30. The liquid supply port 104op is sealed by a film 104f. The liquid supply port 104op is configured to be attachable to and detachable from the liquid introduction section 6 of the accommodation section 4. When the liquid accommodation container 100 is mounted on the carriage 30, the film 104f is broken by the liquid introduction section 6. The ink accommodated in the ink chamber is supplied to the printing head 5 of the printing apparatus 20 via the liquid introduction section 6. As the ink in the ink chamber is consumed, air is introduced into the ink chamber through an atmospheric air opening hole (not illustrated).

A direction in which the liquid accommodation container 100 is mounted on the carriage 30 of the printing apparatus 20 is defined as a mounting direction MD. The mounting direction MD is also a direction in which the substrate 120 is mounted on the carriage 30 of the printing apparatus 20. In the present embodiment, the mounting direction MD is the +Z direction. Two directions orthogonal to each other are referred to as a first direction FD and a second direction SD. The first direction FD is a direction including a component of the mounting direction MD. In the present embodiment, the first direction FD is the Z direction and the second direction SD is the X direction. The first direction FD is a direction substantially along a front surface 120fa of the substrate 120.

The substrate 120 is mounted on the liquid accommodation container 100. In the present embodiment, the substrate 120 is provided on the second wall 101wr of the liquid accommodation body 101. Details of the substrate 120 will be described later.

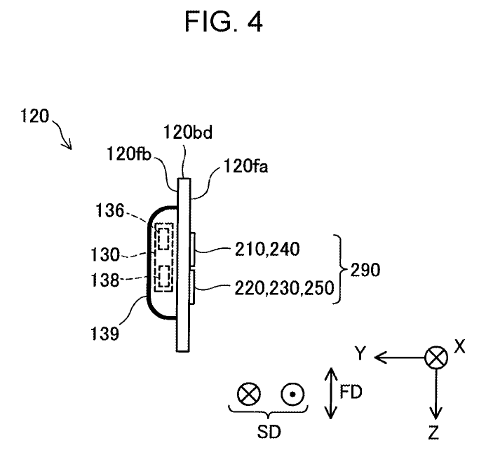

FIG. 4 is an explanatory diagram illustrating a configuration of the substrate 120. The substrate 120 includes a base member 120bd, the terminal group 290, a device 130, and wiring (not illustrated). The base member 120bd has the front surface 120fa and a back surface 120fb. In the present disclosure, the "surface" refers to a surface of the base member 120bd, which faces the apparatus-side terminal group 490 when the liquid accommodation container 100 or the substrate 120 is mounted on the printing apparatus 20. In the present embodiment, the "surface" refers to the front surface 120fa.

The terminal group 290 is electrically coupled to a storage section 138 in the device 130. The terminal group 290 is coupled to the apparatus-side terminals 410 to 450 when the liquid accommodation container 100 is mounted on the printing apparatus 20. The terminal group 290 is formed of a conductor such as gold foil. The terminal group 290 includes a data terminal 210, a clock terminal 220, a power source terminal 230, a reset terminal 240, and a ground terminal 250 (see a middle right portion in FIG. 4 and a lower left portion in FIG. 3).

The data terminal 210 is used for transmitting and receiving data signals between the device 130 and the printing apparatus 20. The signals transmitted and received via the data terminal 210 includes, for example, a signal indicating various kinds of data stored in the storage section 138 provided on the substrate 120, a signal controlled by the processing section 136 provided on the substrate 120 and not stored in the storage section 138, and a signal controlled by the main control section 40 or the sub-control section 50 of the printing apparatus 20 and not stored in the storage section 138. The data terminal 210 is used for detecting whether or not the liquid accommodation container 100 is mounted on the printing apparatus 20.

The clock terminal 220 is used to transmit a clock signal from the printing apparatus 20 to the device 130. The power source terminal 230 is used for supplying a power source voltage VDD from the printing apparatus 20 to the device 130. The reset terminal 240 is used for transmitting a reset signal from the printing apparatus 20 to the device 130. The ground terminal 250 is grounded via the apparatus-side terminal 450 of the printing apparatus 20.

When the liquid accommodation container 100 is mounted on the accommodation section 4, each of the terminals 210, 220, 230, 240, and 250 comes into contact with the corresponding apparatus-side terminals 410, 420, 430, 440, and 450 among the plurality of apparatus-side terminal groups 490 included in the coupling mechanism 400 of the printing apparatus 20.

The device 130 is provided on the base member 120bd. The device 130 is sealed with a resin 139. The device 130 includes the processing section 136 and the storage section 138.

For example, the processing section 136 is configured by a circuit. The processing section 136 is coupled to the terminals 210 to 250 and controls signals and voltages input to and output from the terminals 210 to 250. The processing section 136 may be a circuit having an advanced arithmetic processing function, such as a CPU.

The storage section 138 is configured by, for example, a non-volatile memory such as a flash memory. The storage section 138 stores information on the liquid accommodation container 100. The information on the liquid accommodation container 100 is, for example, an ink consumption, an ink color, a manufacturing date of the liquid accommodation container 100, identification information ID of the liquid accommodation container 100, attachment information Ini, and the like. The ink consumption is recorded as the number of times of discharging the ink droplets using the ink in the liquid accommodation container 100. The identification information ID of the liquid accommodation container 100 is determined for each liquid accommodation container 100. In the present embodiment, "1" to "4" are assigned as the identification information ID to liquid accommodation containers 100A to 100D, respectively. The attachment information Ini represents the number of times the liquid accommodation container 100 is mounted on the printing apparatus 20.

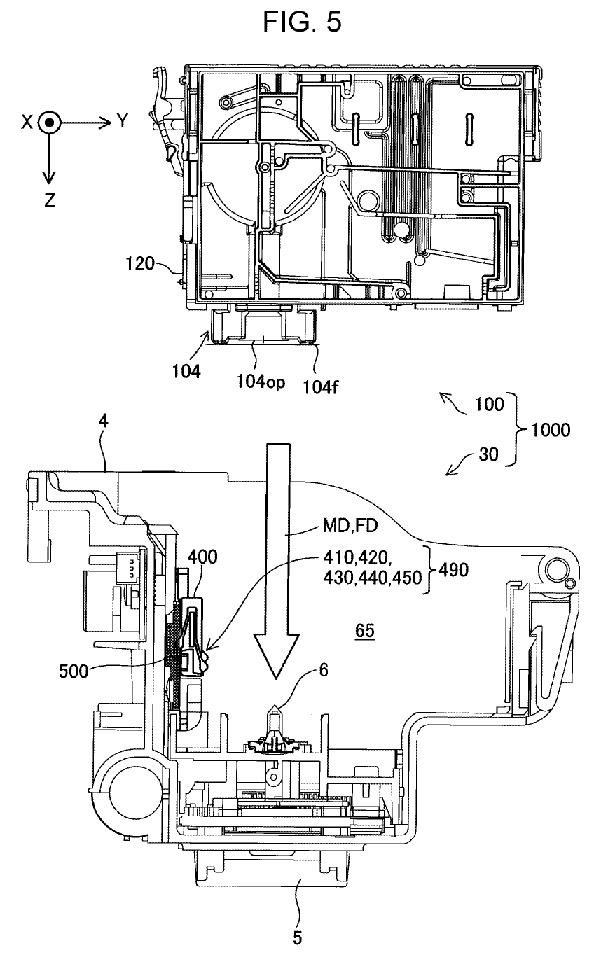

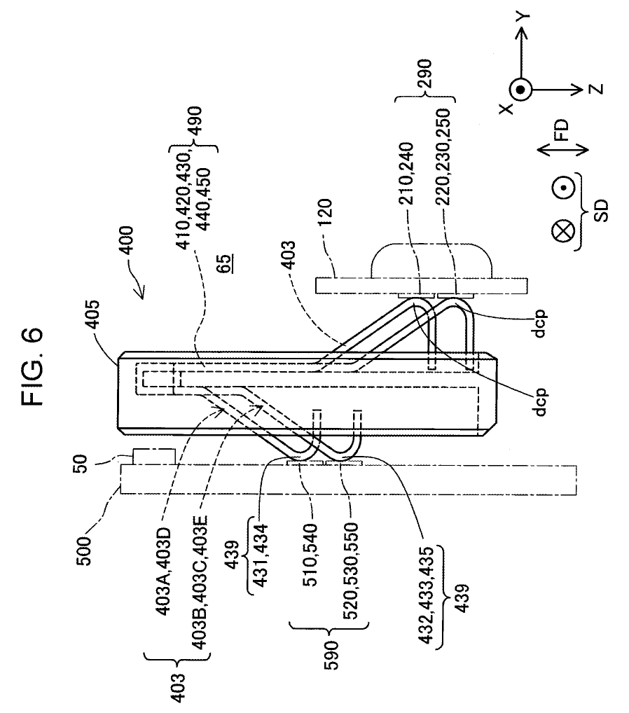

FIG. 5 is a diagram illustrating a state in which the liquid accommodation container 100 is mounted on the carriage 30. FIG. 6 is an enlarged explanatory diagram illustrating the vicinity of the coupling mechanism 400. As illustrated in FIG. 1, the carriage 30 includes the accommodation section 4 and the printing head 5.

The printing head 5 includes a plurality of nozzles and a plurality of piezoelectric elements. The printing head 5 discharges ink droplets from each nozzle in accordance with a voltage applied to each piezoelectric element and forms dots at the print medium PA.

The accommodation section 4 is disposed on the printing head 5 and is configured to be attachable to and detachable from the plurality of liquid accommodation containers 100. Inside the accommodation section 4, a mounting chamber 65 in which the liquid accommodation container 100 is mounted is formed. In the present embodiment, four mounting chambers 65 are provided corresponding to the number of liquid accommodation containers 100A to 100D. The accommodation section 4 is provided with the liquid introduction section 6, the sub-control substrate 500, and the coupling mechanism 400.

The liquid introduction section 6 is disposed on the printing head 5 in the normal usage posture of the printing system 1000. Ink is introduced into the printing head 5 from the liquid supply port 104op of the liquid accommodation container 100 through the liquid introduction section 6. Four liquid introduction sections 6 are provided corresponding to the number of liquid accommodation containers 100A to 100D.

A plurality of sub-control substrate terminals 510, 520, 530, 540, and 550 and the sub-control section 50 are mounted on the sub-control substrate 500. When the plurality of the sub-control substrate terminals 510, 520, 530, 540, and 550 are used without distinction, the reference numeral 590 is used as a sub-control substrate terminal group. The sub-control substrate terminal group 590 is provided for each mounting chamber 65. The sub-control substrate terminal group 590 is electrically coupled to the sub-control section 50 via the wiring of the sub-control substrate 500. The sub-control section 50 is configured as, for example, a carriage circuit, and performs control related to the liquid accommodation container 100 in cooperation with the main control section 40.

The coupling mechanism 400 includes a terminal holding section 405 and a plurality of contact-portion forming members 403 held by the terminal holding section 405. The coupling mechanism 400 is provided for each of the liquid accommodation containers 100A to 100D, that is, for each of the mounting chambers 65. The contact-portion forming member 403 is conductive and elastic. In the present embodiment, for each coupling mechanism 400, five contact-portion forming members 403 are provided, which is the same as the number of the terminal groups 290. When the five contact-portion forming members 403 are used separately, the reference numerals "403A", "403B", "403C", "403D", and "403E" are used.

The contact-portion forming member 403 is a member that electrically couples the terminal group 290 of the liquid accommodation container 100 and the sub-control substrate terminal group 590 of the sub-control substrate 500. A portion of the contact-portion forming member 403, which faces a mounting chamber 65 side, forms the apparatus-side terminal group 490. The apparatus-side terminal group 490 comes into contact with the terminal group 290 illustrated in FIG. 3. In the present embodiment, among the contact-portion forming member 403, a portion facing the mounting chamber 65 side the most, that is, a portion protruding the most toward the mounting chamber 65 side, comes into contact with the terminal group 290. A portion of the contact-portion forming member 403, which protrudes toward the sub-control substrate 500, comes into contact with the sub-control substrate terminal group 590.

When the apparatus-side terminal group 490 is used separately, the reference numerals "410", "420", "430", "440", and "450" are used. When the relay terminals 439 are used separately, the reference numerals "431", "432", "433", "434", and "435" are used. The apparatus-side terminal 410 and the relay terminal 431 are formed at the contact-portion forming member 403A. The apparatus-side terminal 420 and the relay terminal 432 are formed at the contact-portion forming member 403B. The apparatus-side terminal 430 and the relay terminal 433 are formed at the contact-portion forming member 403C. The apparatus-side terminal 440 and the relay terminal 434 are formed at the contact-portion forming member 403D. The apparatus-side terminal 450 and the relay terminal 435 are formed at the contact-portion forming member 403E.

The liquid accommodation container 100 is mounted on the accommodation section 4 of the printing apparatus 20 by being inserted in the mounting direction MD. The liquid accommodation container 100 is pulled out in a direction opposite to the mounting direction MD to be removed from the accommodation section 4. In this way, the liquid accommodation container 100 is attachably and detachably mounted on the printing apparatus 20.

When the liquid accommodation container 100 is mounted on the printing apparatus 20, the terminal group 290 of the liquid accommodation container 100 is pressed against the contact-portion forming member 403 while elastically deforming the contact-portion forming member 403 of the printing apparatus 20. When the liquid accommodation container 100 is removed from the printing apparatus 20, the terminal group 290 of the liquid accommodation container 100 is pulled up with respect to the contact-portion forming member 403 while being pressed by the contact-portion forming member 403 that is elastically deformed. As a result, every time the liquid accommodation container 100 is mounted on and removed from the printing apparatus 20, the terminal group 290 of the liquid accommodation container 100 is subjected to a frictional force from the contact-portion forming member 403. When wear progresses beyond a certain level, or when a plating layer on a surface of the terminal group 290 peels off due to wear, a contact failure can occur between the terminal group 290 of the liquid accommodation container 100 and the contact-portion forming member 403 of the printing apparatus 20.

When the liquid accommodation container 100 is mounted on the accommodation section 4, the device 130 is electrically coupled to the main control section 40 via the terminal group 290, the coupling mechanism 400, the sub-control substrate 500, and the bus 46 illustrated in FIG. 2. Specifically, when the liquid accommodation container 100 is mounted on the accommodation section 4, the terminals 210, 220, 230, 240, and 250 of the substrate 120 come into contact with the apparatus-side terminals 410, 420, 430, 440, and 450 to be electrically coupled, respectively. The apparatus-side terminals 410, 420, 430, 440, and 450 of the coupling mechanism 400 come into contact with the sub-control substrate terminal group 590 on the sub-control substrate 500, thereby being electrically coupled. The sub-control substrate terminal group 590 of the sub-control substrate 500 is electrically coupled to the sub-control section 50 of the printing apparatus 20 by wiring. As a result, each of the terminals 210, 220, 230, 240, and 250 is electrically coupled to the sub-control section 50.

### Electrical Configuration of Printing Apparatus and Liquid Accommodation Container

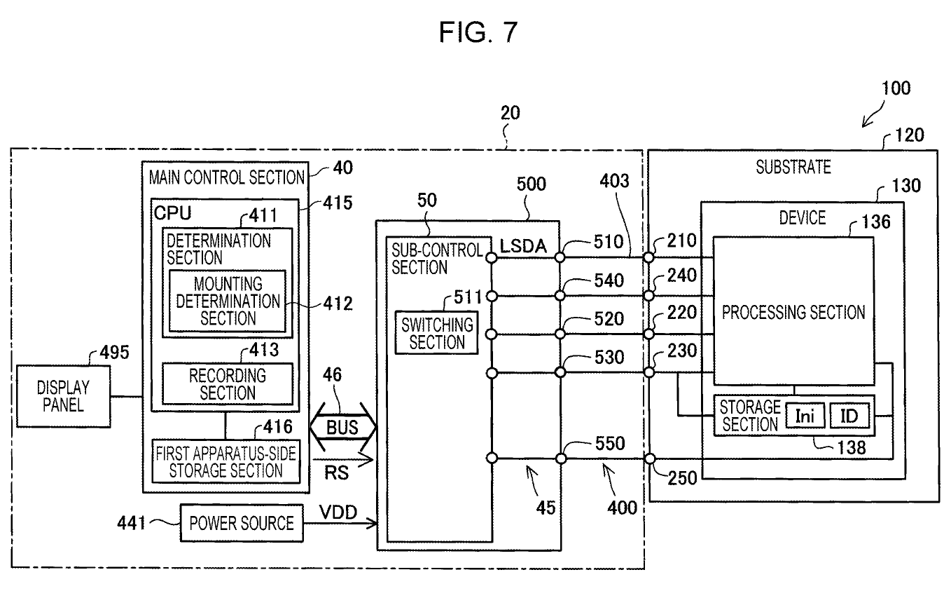

FIG. 7 is a diagram illustrating a functional portion of the printing apparatus 20 together with one liquid accommodation container 100. The printing apparatus 20 includes a display panel 495, a power source 441, the main control section 40, and the sub-control section 50.

The display panel 495 is used to notify a user of an operation state of the printing apparatus 20, an error in the liquid accommodation containers 100A to 100D, the ink consumption stored in the device 130, the ink color, the manufacturing date, and the like. When the liquid accommodation container 100 is in a mounting-completed state, for example, a display informing the user that the liquid accommodation container 100 is mounted, a display indicating that the printing system 1000 is in a printable state, and a display of the remaining amount of the ink accommodated in the liquid accommodation container 100, or the like are made on the display panel 495. The display panel 495 is a liquid crystal display. For example, the display panel 495 is provided in the operation section 60 illustrated in FIG. 2.

The power source 441 is a normal power source used in a logic circuit and has a rating of 3.3 V. The voltage of the power source 441 is supplied to the sub-control section 50 and is also supplied to other circuits as needed.

The main control section 40 includes a CPU 415 and a first apparatus-side storage section 416. The CPU 415 controls the operation of the printing apparatus 20 by executing various programs stored in the first apparatus-side storage section 416. For example, the main control section 40 controls the operation of the display panel 495 or controls the operation of the sub-control section 50. The CPU 415 functions as a determination section 411 and a recording section 413 by executing various programs stored in the first apparatus-side storage section 416. The determination section 411 has a mounting determination section 412. The mounting determination section 412 determines whether or not the liquid accommodation container 100 is mounted. The recording section 413 records information in the storage section 138 of the liquid accommodation container 100.

The sub-control section 50 includes a switching section 511. The switching section 511 switches between a state in which the CPU 415 of the main control section 40 and the substrate 120 are coupled to each other and a state in which the CPU 415 and the substrate 120 are not coupled to each other. The sub-control section 50 transmits request signals RS to each of the devices 130 of the liquid accommodation containers 100A to 100D via a coupling bus 45. The request signal RS includes a command for enabling identification of the liquid accommodation containers 100A to 100D that are response targets to the request signal RS, for each device 130. The determination section 411 performs determination processing of the coupling state of the liquid accommodation containers 100A to 100D by using the voltage output from the data terminal 210 of each of the liquid accommodation containers 100A to 100D in response to the request signal RS.

The processing section 136 of the device 130 communicates with the printing apparatus 20 via data line LSDA. The processing section 136 is electrically coupled to each of the terminals 210 to 250 and the storage section 138.

### Processing in Printing Apparatus

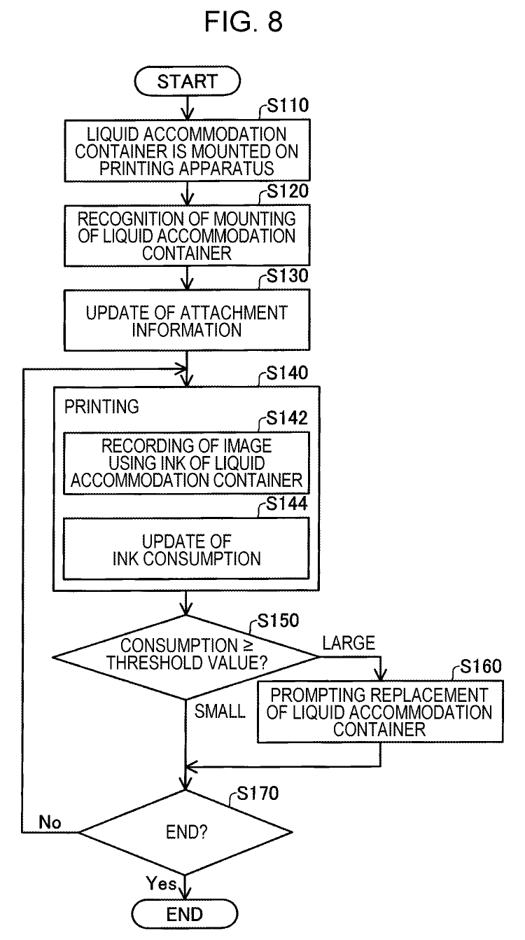

FIG. 8 is a flowchart illustrating processing in the printing apparatus 20. In Step S110, as illustrated in FIG. 1, four liquid accommodation containers 100 are mounted on the printing apparatus 20.

In Step S120, the main control section 40 of the printing apparatus 20 recognizes the mounting of the liquid accommodation container 100 on the printing apparatus 20. Specifically, the mounting determination section 412 of the main control section 40 illustrated in FIG. 7 determines that each liquid accommodation container 100 is physically attached to the printing apparatus 20 and the terminal group 290 of the liquid accommodation container 100 is electrically coupled to the apparatus-side terminal group 490 of the printing apparatus 20. In addition, the identification information ID of each liquid accommodation container 100 is read out from the storage section 138 of each liquid accommodation container 100.

In Step S130, the main control section 40 of the printing apparatus 20 records, in the storage section 138, the number of times the liquid accommodation container 100 is mounted on the printing apparatus 20 as the attachment information Ini illustrated in FIG. 7. Specifically, the recording section 413 of the main control section 40 reads out the attachment information Ini from the storage section 138 via the data line LSDA and the processing section 136. The recording section 413 increases the number of times the liquid accommodation container 100 is mounted on the printing apparatus 20 by one, which is represented by the attachment information Ini. Thereafter, the recording section 413 of the main control section 40 records the attachment information Ini, which represents the increased number of mountings, into the storage section 138 via the data line LSDA and the processing section 136.

The recording section 413 updates the above-described attachment information Ini for each of the four liquid accommodation containers 100, based on the identification information ID read out from the storage section 138 of the liquid accommodation container 100 mounted on the printing apparatus 20, and records the attachment information Ini.

By performing such processing, using the attachment information Ini stored in the storage section 138 of the liquid accommodation container 100, it is possible to determine whether or not the liquid accommodation container 100 is reusable, in consideration of deterioration of the terminal group 290 of the liquid accommodation container 100, which physically contacts a terminal of the printing apparatus 20 and is subjected to a pressing force each time the liquid accommodation container 100 is mounted on the printing apparatus 20. Processing for determination of reuse of the liquid accommodation container 100 will be described later.

In Step S140, the main control section 40 of the printing apparatus 20 executes printing in response to an instruction from the user via the computer PC. More specifically, in Step S142, ink in the liquid accommodation container 100 is used to discharge ink droplets from the printing head 5, and an image is formed at the print medium PA illustrated in FIG. 2. In parallel with the processing, the number of times ink droplets are discharged using ink in the liquid accommodation container 100 is counted. In Step S144, the ink consumption as the number of times ink droplets are discharged using the ink in the liquid accommodation container 100 is added by the recording section 413 of the main control section 40 by the counted number of times. The recording section 413 updates the ink consumption for each of the four liquid accommodation containers 100, based on the identification information ID read out from the storage section 138 of the liquid accommodation container 100 mounted on the printing apparatus 20, and records the ink consumption. The processing of updating the ink consumption includes processing of reading out from the storage section 138, processing of calculation, and processing of writing to the storage section 138, as in the processing of updating the attachment information Ini.

In Step S150, the main control section 40 of the printing apparatus 20 determines whether or not the ink consumption in each liquid accommodation container 100 is larger than a predetermined threshold value. For the liquid accommodation container 100 of which the ink consumption is larger than the predetermined threshold value, the processing of Step S160 is executed. For the liquid accommodation container 100 of which the ink consumption is equal to or less than the predetermined threshold value, the processing of Step S170 is executed.

In Step S160, a message for prompting the replacement of the liquid accommodation container 100 in which the ink consumption is larger than the predetermined threshold value is output. Specifically, the main control section 40 of the printing apparatus 20 causes the message to be displayed on a display of the computer PC via the computer PC. Thereafter, the processing of Step S170 is executed.

In Step S170, the main control section 40 of the printing apparatus 20 determines whether or not an end condition is satisfied. Specifically, the main control section 40 determines whether or not an instruction to end the printing processing is input via an input device of the computer PC. When the end condition is not satisfied, the processing returns to Step S140. When the end condition is satisfied, the processing ends.

### Configuration and Processing of Determination Device

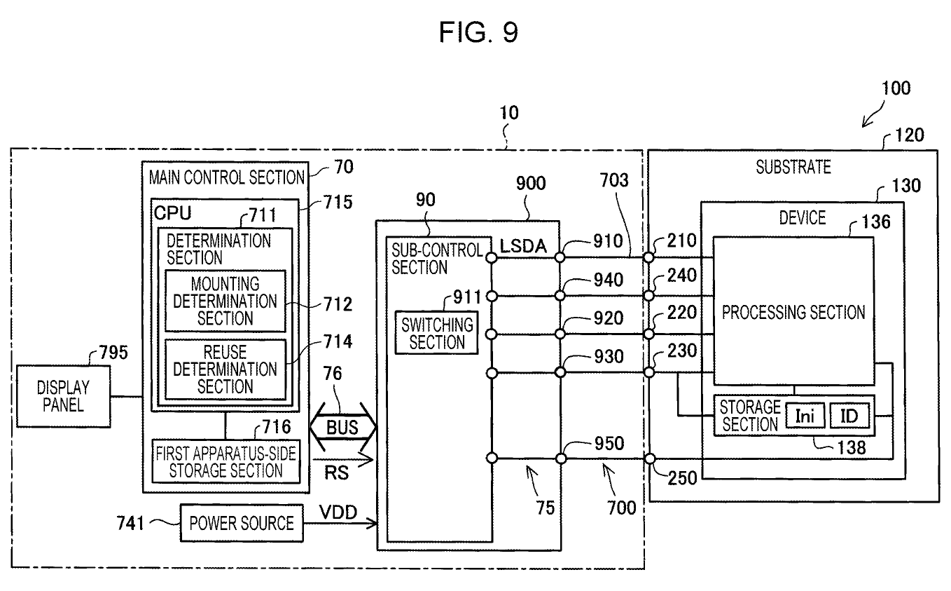

FIG. 9 is a diagram illustrating a functional portion of a determination device 10 together with one liquid accommodation container 100. The determination device 10 constitutes the reuse system 1 of the liquid accommodation container 100 together with the printing apparatus 20 and the liquid accommodation container 100. The determination device 10 determines whether or not a used liquid accommodation container 100 is reusable. The configuration of the determination device 10 is the same as that of the printing apparatus 20 illustrated in FIG. 7, except that the determination device 10 does not include a configuration for executing printing. In FIG. 9, components that provide the same functions as components of the printing apparatus 20 are denoted by reference numerals according to the following rules. When the corresponding component of the printing apparatus 20 has a reference numeral whose first digit is "4", the corresponding component of the determination device 10 is assigned a reference numeral in which the first digit "4" is replaced with "7", and is given the same name. For example, the main control section is indicated by reference numeral 70. When the corresponding component of the printing apparatus 20 has a reference numeral whose first digit is "5", the corresponding component of the determination device 10 is assigned a reference numeral in which the first digit "5" is replaced with "9", and is given the same name. However, in the determination device 10, a determination section 711 includes a reuse determination section 714 instead of the recording section 413. The reuse determination section 714 determines whether or not the used liquid accommodation container 100 is reusable.

The determination device 10 includes a display panel 795, a power source 741, a main control section 70, and a sub-control section 90. A configuration and a function of the display panel 795 are the same as the configuration and function of the display panel 495. A configuration and a function of the power source 741 are the same as the configuration and function of the power source 441.

The main control section 70 includes a CPU 715 and a first apparatus-side storage section 716. A configuration and a function of the first apparatus-side storage section 716 are the same as the configuration and function of the first apparatus-side storage section 416. The CPU 715 functions as the determination section 711 by executing various programs stored in the first apparatus-side storage section 716. The determination section 411 includes a mounting determination section 712 and a reuse determination section 714. A function of the mounting determination section 712 is the same as that of the mounting determination section 412. A function of the reuse determination section 714 will be described later.

A plurality of sub-control substrate terminals 910, 920, 930, 940, and 950 and the sub-control section 90 are mounted on the sub-control substrate 900 (see a central portion in FIG. 9). Configurations and functions of the sub-control substrate terminals 910, 920, 930, 940, and 950 are the same as those of the sub-control substrate terminals 510, 520, 530, 540, and 550. The sub-control section 90 includes a switching section 911. Configurations and functions of the sub-control section 90 and the switching section 911 are the same as the configurations and functions of the sub-control section 50 and the switching section 511.

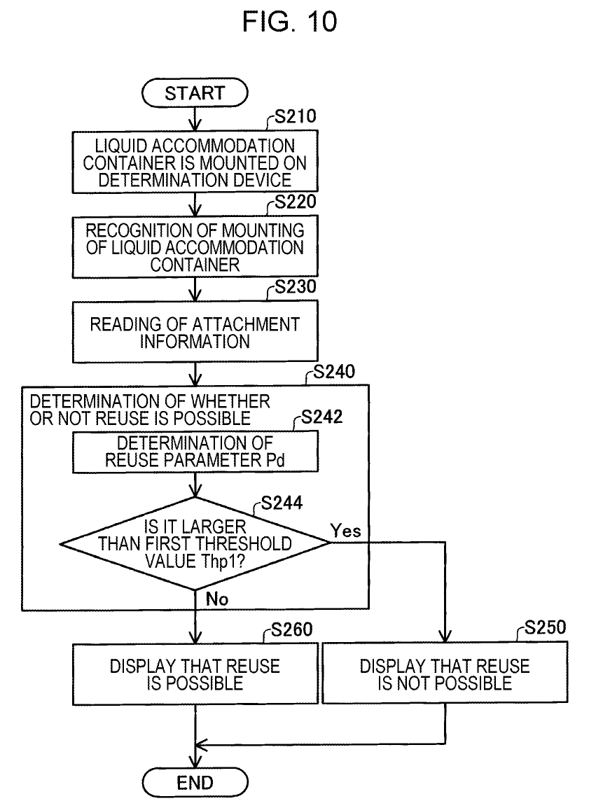

FIG. 10 is a flowchart illustrating processing in the determination device 10. Through the processing of FIG. 10, it is determined whether or not the used liquid accommodation container 100 is reusable. The liquid accommodation container 100 determined to be reusable is reused. The liquid accommodation container 100 determined to be non-reusable is discarded.

In Step S210, the liquid accommodation container 100 is mounted on the determination device 10.

In Step S220, the main control section 70 of the determination device 10 recognizes that the liquid accommodation container 100 is mounted on the determination device 10. Specifically, the mounting determination section 712 of the main control section 70 determines that each liquid accommodation container 100 is physically attached to the determination device 10 and the terminal group 290 of the liquid accommodation container 100 is electrically coupled to the apparatus-side terminal group 490 of the determination device 10 (see a left portion in the middle of FIG. 9). In addition, identification information of each liquid accommodation container 100 is read out from the storage section 138 illustrated in FIG. 9.

In Step S230, the main control section 70 of the determination device 10 reads out the attachment information Ini illustrated in FIG. 9 from the storage section 138. The reuse determination section 714 of the main control section 70 reads out the attachment information Ini from the storage section 138 via the data line LSDA and the processing section 136. The attachment information Ini represents the number of times the liquid accommodation container 100 is mounted on the printing apparatus 20.

In Step S240, the reuse determination section 714 of the main control section 70 of the determination device 10 determines whether or not the used liquid accommodation container 100 is reusable. More specifically, in Step S242, a parameter Pd used for the determination is determined. The parameter Pd is obtained by using the attachment information Ini read out from the storage section 138 of the liquid accommodation container 100 removed from the printing apparatus 20. In the present embodiment, the parameter Pd is the number of times the liquid accommodation container 100 represented by the attachment information Ini is mounted on the printing apparatus 20.

In Step S244, whether or not the liquid accommodation container 100 is reusable is determined based on a comparison between the parameter Pd and a first threshold value Thp1. The first threshold value Thp1 is predetermined and stored in the first apparatus-side storage section 716 of the determination device 10. When the parameter Pd is larger than the first threshold value Thp1, the processing proceeds to Step S250. When the processing proceeds to Step S250, it corresponds to a case where the liquid accommodation container 100 is determined not to be reusable. When the parameter Pd is equal to or less than the first threshold value Thp1, the processing proceeds to Step S260. When the processing proceeds to Step S260, it corresponds to a case where the liquid accommodation container 100 is determined to be reusable.

In Step S250, the main control section 70 of the determination device 10 displays the output indicating that the liquid accommodation container 100 cannot be reused on the display panel 795 of the determination device 10 illustrated in FIG. 9. After Step S250, the processing ends. When the processing of FIG. 10 ends after the processing of Step S250, the liquid accommodation container 100 is discarded.

In Step S260, the main control section 70 of the determination device 10 displays the output indicating that the liquid accommodation container 100 is reusable on the display panel 795 of the determination device 10 illustrated in FIG. 9. After Step S260, the processing ends. When the processing of FIG. 10 ends after the processing of Step S260, the liquid accommodation container 100 is reused.

By performing such processing, it is possible to determine whether or not the liquid accommodation container 100 is reusable, in consideration of deterioration of the terminal group 290 of the liquid accommodation container 100, which physically contacts a terminal of the printing apparatus 20 and is subjected to a pressing force each time the liquid accommodation container 100 is mounted on the printing apparatus 20. As a result, in the reused liquid accommodation container 100, a situation in which a contact failure occurs between the terminal group 290 of the liquid accommodation container 100 and the apparatus-side terminal group 490 of the printing apparatus 20 can be prevented.

The head driving mechanism, the main scanning feeding mechanism, and the sub-scanning feeding mechanism of the printing apparatus 20 in the present embodiment are also referred to as a "printing section". The liquid accommodation container 100 is also referred to as a "consumable cartridge". The apparatus-side terminal group 490 is also referred to as a "first type terminal". The terminal group 290 is also referred to as a "second type terminal".

### Second Embodiment

In the second embodiment, the processing in the determination device 10 illustrated in FIG. 10 includes additional processing. As for other aspects, a reuse system of the liquid accommodation container in the second embodiment is the same as the reuse system 1 of the liquid accommodation container in the first embodiment.

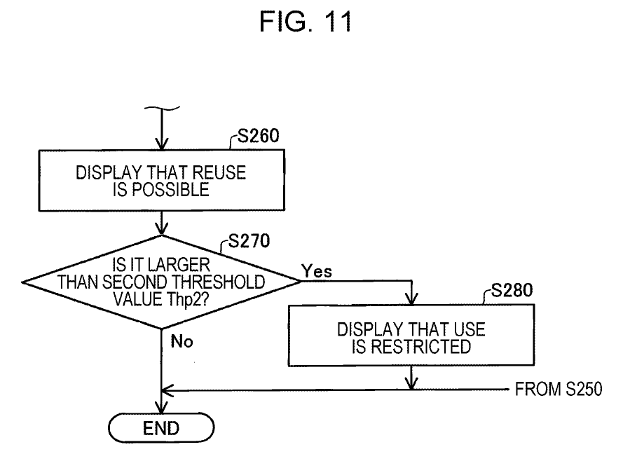

FIG. 11 is a flowchart illustrating an additional portion of the processing in the determination device 10. In the second embodiment, after Step S260, the processing of Step S270 is performed.

In Step S270, the reuse determination section 714 of the main control section 70 determines the use of the liquid accommodation container 100 at the time of reuse based on the parameter Pd. More specifically, the use of the liquid accommodation container 100 is determined based on a comparison between the parameter Pd and a second threshold value Thp2. The second threshold value Thp2 is predetermined and stored in the first apparatus-side storage section 716 of the determination device 10. The second threshold value Thp2 is smaller than the first threshold value Thp1. When the parameter Pd is larger than the second threshold value Thp2, the processing proceeds to Step S280. When the parameter Pd is equal to or less than the second threshold value Thp2, the processing ends.

In Step S280, the main control section 70 of the determination device 10 displays the output indicating that the use of the liquid accommodation container 100 is restricted on the display panel 795 of the determination device 10 illustrated in FIG. 9. After Step S280, the processing ends. When the processing of FIG. 11 ends after the processing of Step S280, the use of the reused liquid accommodation container 100 is restricted. The restricted use refers to, for example, a use in a region where an environment in which a load on the liquid accommodation container 100 is small is assumed, specifically, a destination restricted to a case where the temperature and humidity of the environment are within a predetermined range, a use in the printing apparatus 20 in which the liquid accommodation container 100 is removed at a low frequency or the liquid accommodation container 100 cannot be removed, and the like.

By performing such processing, the possibility that a problem occurs in the reused liquid accommodation container 100 can be reduced. That is, for the liquid accommodation container 100 having a large number of reuses, it is possible to set the destination to a region where an environment in which the load on the liquid accommodation container 100 is small is assumed, or to restrict the printing apparatus 20 in which the liquid accommodation container 100 can be mounted to the printing apparatus 20 in which the liquid accommodation container 100 is removed at a low frequency or the liquid accommodation container 100 cannot be removed. As a result, the possibility that a problem occurs in the reused liquid accommodation container 100 can be reduced.

### Other Embodiments

### Other Embodiment 1

1. In the above embodiment, as illustrated in FIG. 8, in Step S110, the printing is executed in Step S140 after the liquid accommodation container 100 is mounted on the printing apparatus 20. However, after the liquid accommodation container 100 is mounted on the printing apparatus 20, the liquid accommodation container 100 may be removed from the printing apparatus 20 without executing the printing. Even in such a case, in Step S130, the number of times the liquid accommodation container 100 is attached, including the mounting in Step S110 immediately before, is recorded in the storage section 138 as the attachment information Ini by the main control section 40 of the printing apparatus 20.

The removal of the liquid accommodation container 100 from the printing apparatus 20 is not limited to the case where a message prompting replacement of the liquid accommodation container 100 is displayed in Step S160. For example, before performing a large amount of color printing, the user may replace all the liquid accommodation containers 100 with unused liquid accommodation containers 100 regardless of the remaining amount of ink in each liquid accommodation container 100. Similarly, before performing a large amount of monochrome printing, the user may replace the liquid accommodation container 100 that accommodates black ink with the unused liquid accommodation container 100 regardless of the remaining amount of ink. In such a case, the printable liquid accommodation container 100 removed from the printing apparatus 20 is attached to the printing apparatus 20 again when performing a small amount of printing, and is used for printing. Therefore, the attachment information Ini that represents the number of times the liquid accommodation container 100 is mounted on the printing apparatus 20 reflects, more appropriately than the number of times the liquid accommodation container 100 is reused, terminal deterioration and, consequently, a guideline for the determination of whether or not the liquid accommodation container 100 may be reused.

2. In the above embodiment, as illustrated in FIG. 10, the parameter Pd is the number of times the liquid accommodation container 100 represented by the attachment information Ini is mounted on the printing apparatus 20. In Step S244, when the parameter Pd is larger than the first threshold value Thp1, it is determined that the liquid accommodation container 100 cannot be reused. However, the parameter Pd used for determining whether or not the liquid accommodation container 100 is reusable may be another value.

For example, the parameter Pd used for determining whether or not the liquid accommodation container 100 is reusable may be a weighted sum of the number of times the liquid accommodation container 100 is mounted on the printing apparatus 20 and the number of times the liquid accommodation container 100 is reused. The parameter Pd used for determining whether or not the liquid accommodation container 100 is reusable may be a parameter that represents printability determined by referring to a table based on the number of times the liquid accommodation container 100 is mounted on the printing apparatus 20 and the number of times the liquid accommodation container 100 is reused. The number of times the liquid accommodation container 100 is reused can be incremented each time the liquid accommodation container 100 is reused by the same function as the recording section 413 of the printing apparatus 20 provided by the determination device 10, and can be recorded in the storage section 138 of the liquid accommodation container 100.

In addition, the parameter Pd used for determining whether or not the liquid accommodation container 100 is reusable may be a parameter that increases to determine that the liquid accommodation container 100 cannot be reused, or may be a parameter that decreases to determine that the liquid accommodation container 100 cannot be reused. However, the parameter Pd used for determining whether or not the liquid accommodation container 100 is reusable is preferably obtained by using information read out from the storage section of the consumable cartridge removed from the printing apparatus.

3. In the second embodiment, as illustrated in FIG. 11, the use of the liquid accommodation container 100 is determined based on a comparison between the parameter Pd and the second threshold value Thp2. However, the determination of the use of the liquid accommodation container 100 may be made based on a parameter different from the parameter Pd used for the determination of whether or not the liquid accommodation container 100 is reused, for example, the number of times the liquid accommodation container 100 is reused. However, the parameter used for determining the use of the liquid accommodation container 100 is preferably a parameter obtained by using the attachment information Ini read out from the storage section 138 of the liquid accommodation container 100.

4. In the above embodiment, it is determined whether or not the liquid accommodation container 100 as a consumable cartridge is reusable. However, the consumable cartridge for which reusability is determined may be a toner cartridge that supplies toner to a laser printer, or may be another consumable cartridge such as a tape cartridge that supplies a tape as a print medium to a label printer. However, it is preferable that the consumable cartridge for which reusability is determined involves contact and separation between the terminals when being attached and removed.

### Other Embodiment 2

In the above embodiment, the accommodation section 4 of the printing apparatus 20 is configured to attachably and detachably mount four liquid accommodation containers 100. The recording section 413 updates the attachment information Ini illustrated in FIG. 7 for each of the four liquid accommodation containers 100, based on the identification information ID read out from the storage section 138 of each liquid accommodation container 100, and records the attachment information Ini. However, the printing apparatus is configured to allow mounting of another number of consumable cartridges such as two, six, or eight, and may update the attachment information Ini and record the attachment information Ini for each of the liquid accommodation containers 100. Further, when the printing apparatus is configured to allow mounting of one consumable cartridge, the attachment information Ini may be updated and the attachment information Ini may be recorded for the liquid accommodation container 100 regardless of identification information.

### Other Embodiment 3

In the second embodiment described above, the use of the liquid accommodation container 100 is determined based on a comparison between the parameter Pd and the second threshold value Thp2 illustrated in FIG. 11. However, as described above in the first embodiment, with respect to the liquid accommodation container 100 determined to be reusable, it is also possible to adopt an aspect in which a determination regarding the use is not made.

### Other Aspects

The present disclosure is not limited to the above-described embodiments, and can be realized in various aspects without departing from the gist thereof. For example, the present disclosure can also be realized in the following aspects. Technical features in the above embodiments corresponding to technical features in respective aspects described below can be appropriately replaced or combined in order to solve some or all of the problems of the present disclosure, or achieve some or all of the effects of the present disclosure. In addition, when the technical features are not described as essential in the present specification, the technical features can be appropriately deleted.

1. According to an aspect of the present disclosure, there is provided a consumable cartridge reuse system. The consumable cartridge reuse system includes a printing apparatus including a first type terminal, a consumable cartridge configured to be attached to and detached from the printing apparatus, the consumable cartridge including a storage section that stores information and a second type terminal that is electrically coupled to the storage section and is coupled to the first type terminal when the consumable cartridge is mounted on the printing apparatus, and a determination device configured to determine whether or not a used consumable cartridge is reusable. The printing apparatus is configured to record, as attachment information, the number of times the consumable cartridge is mounted on the printing apparatus in the storage section of the consumable cartridge mounted on the printing apparatus. The determination device determines whether or not the consumable cartridge is reusable, based on a comparison between a parameter obtained by using the attachment information read out from the storage section of the consumable cartridge removed from the printing apparatus and a threshold value.

By adopting such an aspect, it is possible to determine whether or not the consumable cartridge is reusable in consideration of deterioration of terminals that physically contact with terminals of the printing apparatus and are subjected to a pressing force each time the consumable cartridge is mounted on the printing apparatus.

2. In the reuse system according to the above aspect, the consumable cartridge may store identification information determined for each consumable cartridge in the storage section, the printing apparatus may be configured to mount a plurality of consumable cartridges, and the printing apparatus may record, based on the identification information read out from the storage section of one or more consumable cartridges mounted on the printing apparatus, the attachment information for each of the one or more consumable cartridges.

By adopting such an aspect, the printing apparatus can execute processing according to the identification information.

3. In the reuse system according to the above aspect, the determination device may determine a use of the consumable cartridge based on the parameter obtained by using the attachment information read out from the storage section when the consumable cartridge is reusable.

By adopting such an aspect, for example, the possibility of a problem in the reused consumable cartridge can be reduced by the following correspondence. That is, for the consumable cartridge having a large number of reuses, the destination may be set to a region assumed to be an environment with a small load on the consumable cartridge, or the printing apparatuses in which the consumable cartridge can be mounted may be restricted to the printing apparatuses in which the consumable cartridge is removed at a low frequency or the consumable cartridge cannot be removed.

4. According to another aspect of the present disclosure, there is provided a consumable cartridge reuse method. The consumable cartridge reuse method includes recording, as attachment information, the number of times a consumable cartridge is mounted on a printing apparatus in a storage section included in the consumable cartridge configured to be attached to and detached from the printing apparatus, and determining whether or not the consumable cartridge is reusable based on a comparison between a parameter obtained by using the attachment information read out from the storage section of the consumable cartridge removed from the printing apparatus and a threshold value.

5. In the reuse method according to the above aspect, the reuse method further includes determining a use of the consumable cartridge based on the parameter obtained by using the attachment information read out from the storage section when the consumable cartridge is reusable.

6. According to still another aspect of the present disclosure, there is provided a printing apparatus. The printing apparatus includes a printing section configured to perform printing by using a consumable cartridge mounted on the printing apparatus, the consumable cartridge being configured to be attached to and detached from the printing apparatus and including a storage section that stores information, and a recording section configured to record, as attachment information, the number of times the consumable cartridge is mounted on the printing apparatus in the storage section of the consumable cartridge.

7. In the printing apparatus according to the above aspect, the consumable cartridge may store identification information determined for each consumable cartridge in the storage section, the printing apparatus may be configured to mount a plurality of consumable cartridges, and the recording section may record, based on the identification information read out from the storage section of one or more consumable cartridges mounted on the printing apparatus, the attachment information for each of the one or more consumable cartridges.

The present disclosure can also be realized in various aspects other than the consumable cartridge reuse system, the consumable cartridge reuse method, and the printing apparatus. For example, the present disclosure can be realized in various aspects such as a management method of a consumable cartridge and a management system of a consumable cartridge.

What is claimed is:

1. A consumable cartridge reuse system comprising:
a printing apparatus including a first type terminal;
a consumable cartridge configured to be attached to and detached from the printing apparatus, the consumable cartridge including a storage section that stores information and a second type terminal that is electrically coupled to the storage section and is coupled to the first type terminal when the consumable cartridge is mounted on the printing apparatus; and
a determination device configured to determine whether or not a used consumable cartridge is reusable, wherein
the printing apparatus is configured to record, as attachment information, the number of times the consumable cartridge is mounted on the printing apparatus in the storage section of the consumable cartridge mounted on the printing apparatus, and
the determination device determines whether or not the consumable cartridge is reusable, based on a comparison between a parameter obtained by using the attachment information read out from the storage section of the consumable cartridge removed from the printing apparatus and a threshold value.

2. The consumable cartridge reuse system according to claim 1, wherein
the consumable cartridge stores identification information determined for each consumable cartridge in the storage section,
the printing apparatus is configured to mount a plurality of consumable cartridges, and
the printing apparatus records, based on the identification information read out from the storage section of one or more consumable cartridges mounted on the printing apparatus, the attachment information for each of the one or more consumable cartridges.

3. The consumable cartridge reuse system according to claim 1, wherein
the determination device determines a use of the consumable cartridge based on the parameter obtained by using the attachment information read out from the storage section when the consumable cartridge is reusable.

4. A consumable cartridge reuse method comprising:
recording, as attachment information, the number of times a consumable cartridge is mounted on a printing apparatus in a storage section included in the consumable cartridge configured to be attached to and detached from the printing apparatus; and
determining whether or not the consumable cartridge is reusable based on a comparison between a parameter obtained by using the attachment information read out from the storage section of the consumable cartridge removed from the printing apparatus and a threshold value.

5. The consumable cartridge reuse method according to claim 4, further comprising:
determining a use of the consumable cartridge based on the parameter obtained by using the attachment information read out from the storage section when the consumable cartridge is reusable.

6. A printing apparatus comprising:
a printing section configured to perform printing by using a consumable cartridge mounted on the printing apparatus, the consumable cartridge being configured to be attached to and detached from the printing apparatus and including a storage section that stores information; and
a recording section configured to record, as attachment information, the number of times the consumable cartridge is mounted on the printing apparatus in the storage section of the consumable cartridge.

7. The printing apparatus according to claim 6, wherein
the consumable cartridge stores identification information determined for each consumable cartridge in the storage section,
the printing apparatus is configured to mount a plurality of consumable cartridges, and
the recording section records, based on the identification information read out from the storage section of one or more consumable cartridges mounted on the printing apparatus, the attachment information for each of the one or more consumable cartridges.
